(19) United States
(12) Patent Application Publication
(10) Pub. No.: US 2019/0068112 A1
(43) Pub. Date: Feb. 28, 2019

(54) TRACKER SYSTEM

(71) Applicant: QuantPower, Fremont, CA (US)

(72) Inventors: Bhagawan Gnanapa, Hyderabad (IN); Beilei Zhou, Shanghai (CN)

(21) Appl. No.: 15/692,700

(22) Filed: Aug. 31, 2017

(51) Int. Cl. H02S 20/32; H02S 30/10; F16M 11/10; F16M 11/18

(52) U.S. Cl. CPC H02S 20/32; F16M 11/18; F16M 11/10; H02S 30/10

(57) ABSTRACT

A system is described for tracking light energy, or solar energy, on at least one axis. The system may include a single PV module or a system or plurality of PV modules. The system may include a bearing system that may allow for single axis rotation of the PV while providing greater ease of rotation as well as greater reliability in the bearing system. The system may function with a single PV module, single motor and actuator. The system may also function with multiple rows of PV modules and provide for a greater number of PV modules with a single motor, single actuator and multiple torque tubes with multiple bearing systems.

### CROSS-REFERENCE TO RELATED APPLICATIONS

This application incorporates the following patents or applications, in their entirety, by reference: U.S. Pat. No. 8,705,914 titled REDIRECTING OPTICS FOR CONCENTRATION AND ILLUMINATION SYSTEMS and U.S. Pat. No. 8,561,878 titled LINEAR CELL STRINGING.

### TECHNICAL FIELD

This disclosure relates generally to methods and systems utilizing Photovoltaic (PV) cells or solar cells and a system for tracking the movements of the sun. These systems relate more specifically to solar trackers and the use of optics to concentrate sunlight into photovoltaic receivers and the apparatus used for this light collection.

### RELATED ART

Photovoltaic (PV) cells or solar cells are electronic devices that convert solar energy, or light energy into electricity. The PV cells themselves are, roughly, manufactured from circular silicon wafers and are often cut into a rectangular shape with the corners cut off. The PV cells are then placed within a PV module side by side. A standard PV module may include cells placed in a frame in a format of 6 cells by 10 cells (6×10), or 6 cells by 12 cells (6×12) or other formats.

Solar trackers often are utilized to track the movements of the sun and can track the sun's movements based on a single pivot or multiple pivots. Many trackers may only be manipulated along a single axis and thus rotate the PV modules about that single axis. Other trackers are able to move along two or more axes allow the tracker to manipulate PV cells in more than a single rotation direction.

Most trackers utilize time to track the motion of the sun with the use of motors; however, a sensor may be used to follow the direction of the sun and then communicate with a motor or motors of the tracker to manipulate the position of the tracker relative to the position of the sun. Single axis trackers often have a single pivot point that is able to rotate the PV modules about an axis. The pivot points have typically been a bushing that will grip and secure a main post that runs the length of the series of PV modules that are connected to the pivot system. A common failure point of tracker systems can be the point where the tracker system connects to the main cross-bar that holds the PV modules in a common direction.

Trackers often have a series of PV modules that extend from a central point of the system. The typical number of PV modules in a single tracker system may be four to as many as 16. However, the great number of PV modules the more difficult it is to prevent “sagging” toward the ends of the tracker systems because of the weight of the PV modules. Additionally the greater number of PV modules the stronger the motor is required to rotate the PV modules to track the sun.

Another feature of common tracker systems include the support beams that may be positioned at intervals between a series of PV modules. Often the number of PV modules and their intervals causes the PV modules that are the furthest from a central point of the entire system are not as well supported or “sag” compared to those cells that are closer to the central point of the tracker system. Some solutions have included support members positioned at different intervals of the tracker systems.

The PV cells in a PV module are wired or soldered together in a series to create a higher additive voltage. The PV modules are necessarily waterproof or water-resistant so as not to short the electronics and electrical connections. Often a sheet of glass covers a sun-facing side of the module. Each PV module may include its own power box that captures the electricity produced from the PV cells or a series of PV modules and even a series of trackers with a series of modules may transfer the electricity to a single power box.

PV cells tend to have a standard length and width of, roughly, 156 mm×156 mm. These are then placed together in a PV module as set forth above. PV cells may be cut into any different sizes and or shapes but the industry standard tends to be the 156 mm×156 mm.

Mirrors and other reflectors have been used in the solar energy art to help harness more of the solar energy into PV cells. However, by utilizing trackers it allows the PV modules with the PV cells to harness more of the solar energy throughout the day than those PV modules that are stationary.

### SUMMARY

This disclosure, at least in one aspect, relates to the use of a tracker system to manipulate a series of PV modules about at least one axis. The tracker system, or the system, may rotate following the direction of the sun to capture solar energy onto the PV cells within the PV modules. The tracker system may include a motor configured to rotate the system about an axis. The motor may be connected to an actuator which is secured to a control bar that is able to manipulate the cross bar that engages each of the PV modules. The cross bar may be substantially rectangular in cross-section but may be any polygonal shape.

The motor is able to manipulate the actuator such that it moves the control bar rotationally about the axis. The control bar may be secured to the cross bar, or torque tube, by any typical means known in the art such as square bolts or square nuts with complementary bolts that secure opposite the square nuts or U-bolts with nuts, as well as hexagonal bolts and nuts. Brackets may also be used that are able to reversible secure the cross bar to the control bar. The control bar may also be welded to the cross bar. The actuator, control bar and motor may be in communication at a joint that allows the control bar to move relative to the cross bar, while the cross bar axially rotates, but does not move laterally or transversely.

Additionally a single motor and actuator may control multiple tracker systems. In one embodiment the system may include an actuation rod that extends from the actuator to additional tracker systems. Each tracker system may include the control bar that is secured to a cross bar. Each cross bar may include a plurality of PV modules similar to or identical to the first tracker system. The actuator rod may be a single rod that each separate control rod is secured to or it may be multiple actuator rods in communication with the actuator. Each control rod that may be secured to an actuator rod may be pivotally connected at a joint that allows for movement of the actuator rod and the control rod while only axially rotating the cross bar.

Support bars, or pedestal poles, may be positioned in the system to support the plurality of PV modules that are secured to the cross bar. The support bars may be placed lateral to the actuator and control bar. A first set of support bars may be lateral the actuator but prior a first PV module. Additional support rods may be positioned laterally after 6 PV modules and again after 7 PV modules and then again after 7 PV modules. Thus there are 4 support members on a first lateral side of the system and 4 support members on a second lateral side of the system. The positioning of the support members is to prevent sagging of the cross bar at one or multiple locations. The support members may also be of different sizes and instead of the typical 6×12 rectangular pedestal poles the system may use 6×9 rectangular pedestal poles to save on cost and overall weight of the system without compromising stability and strength. Alternatively the support members may be comprised of standard 2×4s in metal or wood. Alternatively, the pedestal poles, or support members may have the following dimensions 120 mm×60 mm. It will be appreciated that the support members can vary in dimensions and may vary from 80 mm-140 mm×40 mm-80 mm. the pedestal poles may also be solid rectangular members or I-beams.

The number of PV modules of the tracker system may be 40, or 20 on each side. Each set of PV modules may be in a format of (i) 6, 7, 7; or (ii) 7, 7, 6; or (iii) 6, 6, 6, 2. Often the PV modules are in sets of 20 PV modules, on each side of the tracker assembly, in 1000v systems and in sets of 30 PV modules, on each side of the tracker assembly, for 1500v systems. With the support members and the spacing of the PV modules more PV modules are able to be manipulated in a single system and the support members prevent sagging or deformation.

Each of the PV modules is secured to the cross bar and may be secured with the same or similar brackets as described earlier for secured the control bar to the cross bar. The tracker system may include bearing system. The bearing system includes spherical bushings with a center cutout, or central hole, that is substantially the same shape as the cross bar. The bushings may include a first L-shaped piece and a second L-shaped piece that fit complementary together to form the spherical bushing. The bushing may be positioned within a cylindrical member that holds the busing in place but allows it to freely rotate within the cylindrical member. The bushing and the cylindrical member also provide alignment tolerance and allow some “play” between the two pieces. The cylindrical member may be circumferentially surrounded by a bracket, or set of brackets, that secures the bearing system to the support members.

With the PV modules secured to the cross bar and the cross bar capable of axially rotation because of the control member rotating the cross bar when acted upon by the actuator from the motor, the PV modules rotate about the axis and are able to follow the direction of the sun.

Other bearing systems and designs may be utilized to accomplish a similar function and will be described further herein. Additionally a tracker system for a single PV module, utilizing similar designs, elements and functions is also contemplated and further described herein.

### BRIEF DESCRIPTION OF THE DRAWINGS

In the drawings:

FIG. 1 illustrates a top view of a tracker system with a plurality of PV modules and a tracker mechanism;

FIG. 2 illustrates a closer top view of the connection point of a control bar and a cross bar of the tracker system of FIG. 1;

FIG. 3 illustrates a top view of an alternate tracker system with a plurality of PV modules;

FIG. 4 illustrates a closer top view of the connection point of a control bar and a cross bar of the tracker system of FIG. 3 which is similar to FIG. 1;

FIG. 5 illustrates a side view of the tracker system of either FIG. 1 or FIG. 3 with an actuator, the control bar and the cross bar in a first configuration;

FIG. 5A illustrates a side view of the tracker system of either FIG. 1 or FIG. 3 with an actuator, the control bar and the cross bar in a second configuration

FIG. 6 illustrates a closer view of the tracker mechanism with a joint and the tracker mechanism of FIG. 5;

FIG. 7 illustrates a back view of the tracker system of FIG. 1 with support members or pedestal posts;

FIG. 8 illustrates a closer side view of the tracker system with the tracker mechanism of FIG. 1:

FIG. 9 illustrates a closer side view of a support member of the tracker system of FIG. 1;

FIG. 10 illustrates a perspective view of the tracker system of FIG. 1;

FIG. 11 illustrates close up perspective view of the tracker system of FIG. 1 with the tracker mechanism with an actuator, the control rod and a motor;

FIG. 12 illustrates a side view of a tracker system with a single row of PV modules;

FIG. 13 illustrates a top view of the tracker system of FIG. 12;

FIG. 14 illustrates a side view of a tracker system in a first configuration with a single PV module;

FIG. 15 illustrates a side view of the tracker system of FIG. 14 in a second configuration;

FIG. 16 illustrates a side view of the tracker system of FIG. 14 in a third configuration;

FIG. 17 illustrates a cross-bar from any one of FIG. 1, 12 or 14 with a cross bar section, a support member, a bracket, and a bushing, or bearing, a bearing housing and with the cross bar passing through the bushing;

FIG. 17A illustrates a cross-bar from any one of FIG. 1, 12 or 14 with a cross bar section, a rectangular support member, a bracket, and a bushing, or bearing, a bearing housing and with the cross bar passing through the bushing;

FIG. 18 illustrates a perspective view of a the tracker system of FIG. 14 without the PV module;

FIG. 19 illustrates an exploded perspective view of the bearing system of the tracker system of any one of FIG. 1, 12 or 14, with the cross bar, the bushing, the bearing housing, the bracket and the support member;

FIG. 20 illustrates a perspective view of the bearing housing of FIG. 19;

FIG. 21 illustrates a perspective view of the bushing of FIG. 19 with substantial L-shape pieces;

FIGS. 22-23 illustrate an assembled and exploded perspective view, respectively, alternate embodiment of the bearing system of FIG. 19;

FIG. 24 illustrates a bushing with a substantial U-shape;

FIGS. 25-26 illustrate an assembled and exploded perspective view, respectively, alternate embodiment of the bearing system of FIG. 19;

FIGS. 27-28 illustrate an assembled and exploded perspective view, respectively, alternate embodiment of the bearing system of FIG. 19;

FIGS. 29-30 illustrate an assembled and exploded perspective view, respectively, alternate embodiment of the bearing system of FIG. 19;

FIGS. 31-32 illustrate an assembled and exploded perspective view, respectively, alternate embodiment of the bearing system of FIG. 19; and

FIGS. 33a-33c illustrates an alternate embodiment of the tracker system of FIG. 1.

### DETAILED DESCRIPTION

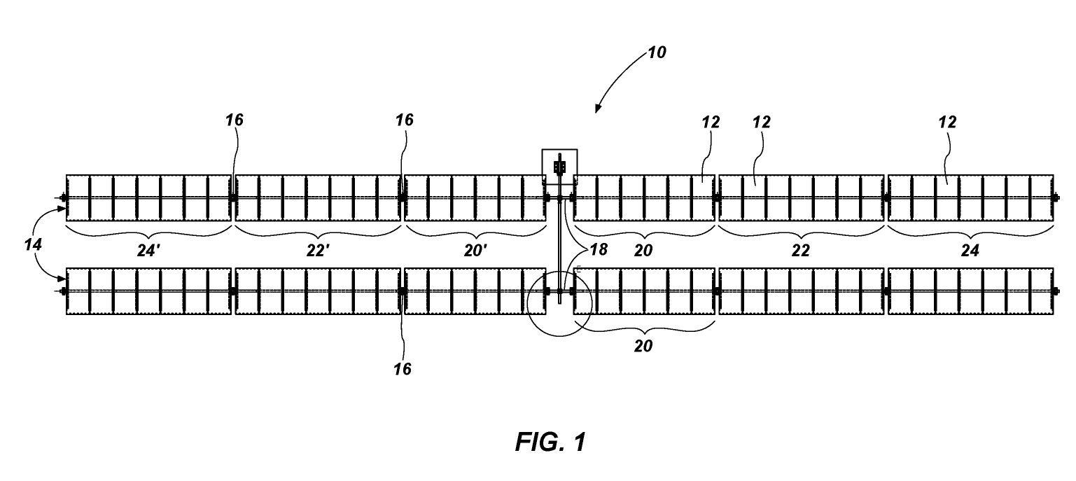

FIG. 1 illustrates an embodiment of a solar tracker system 10, or tracker system, or system that includes a series of PV modules 12. A plurality of rows 14 of PV modules may be utilized with the system 10. While only two rows 14 of modules may be depicted it will be appreciated that any number of rows of PV modules 12 may function within the system 10. Each row 14 of PV modules may include support members 16, or support posts, or posts that may engage a cross bar 18, or torque tube, of the system 10. The PV modules may each be secured to a frame 17 that is secured to the cross bar 18. The posts 16 may be positioned at strategic locations in each row 14 to adequately support the PV modules and to prevent sagging of the cross bar 18 and thus the PV modules 12 as well. The PV modules 12 may be secured to the cross bar 18 with each PV module 12 evenly spaced between each other. The series of PV modules 12 may also be positioned strategically between the posts 16 in such a way to maximize the number of PV modules 12 while preventing sagging and allowing the system to adequately and efficiently tract the sun. A first set, or series, of PV modules 12 that extend from a central position of the system 10 may include a first set of PV modules 20, 20′, which may comprise six (6) PV modules that extend laterally from the center position. A second set of PV modules 22, 22′, which may comprise seven (7) PV modules, may extend laterally from the first set of PV modules 20, 20′. A third set of PV modules 24, 24′, which may comprise seven (7) PV modules, may extend laterally from the second set of PV modules 22, 22′. Support members 16 may be positioned just lateral the center position or toward the center position and then another support member after the first set of PV modules 20, 20′ and then another support member 16 after the second set of PV modules 22, 22′ and then a last support member 16 after the third set of PV module 24, 24′ which may be at the end of the row 14 toward the end of the cross bar 18.

Support members 16 may be different sizes, widths, length, depth and shapes to reduce the overall cost of the tracker system 10. Previously typical sizes for posts were a standard 12×6. While the current design may utilize a single 6×12 post the remaining posts may be 6×9 which may allow the same degree of stability and strength but overall material utilized is far less and costs are lower. The smaller posts, or support members 16, may be utilized the further from the center position.

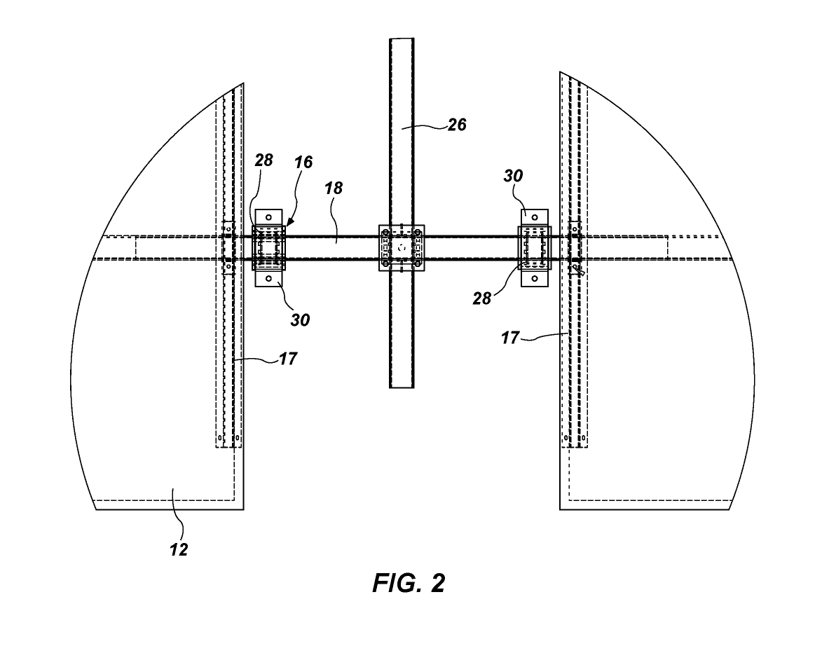

Referring to FIG. 2, a close up view of the control bar 26, or torque arm, is depicted engaged with the cross bar 18. At least two support members 16 are each engaged with a bushing 28 which is configured to engage the cross bar 18 such the cross bar 18 is rotated with the bushing allowing the PV modules to rotate about the axis of the cross bar 18. The bushings 28 may be secured to the support members via brackets 30 which may circumferentially engage the bushings 28. The first set of PV modules 20, 20′ may be positioned just lateral the first set of support members 16, brackets 30 and bushings 28. The control bar 26 may engage the cross bar via a standard U-bolts or brackets with nuts and bolts. The cross bar 18 may be substantially rectangular in cross section but may be any polygonal shape. Likewise the control bar 26 may be substantially rectangular in cross section but may be any polygonal shape with sufficient means to secure the control bar 26 with the cross bar 18.

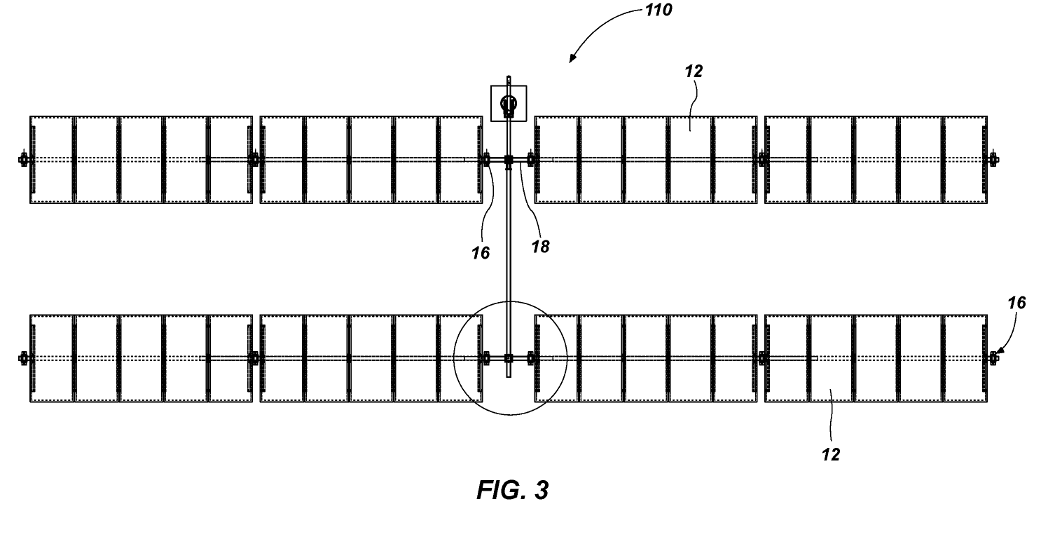

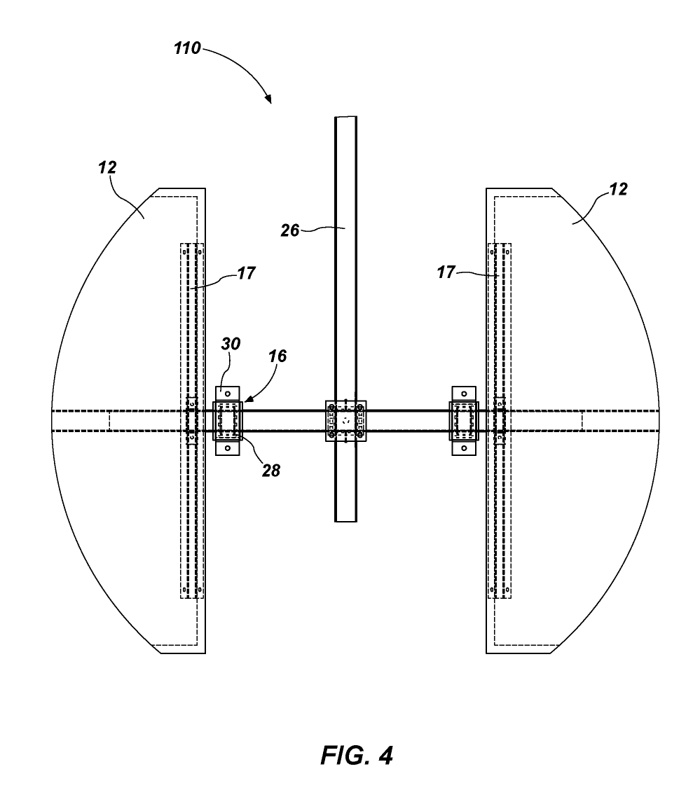

Referring to FIGS. 3 and 4, an alternate embodiment of the tracker system 110 is depicted. While the mechanism and method of use may be substantially similar, the number of PV modules 12 and spacing may vary with less PV modules 12 and support members 16 as the previous embodiment.

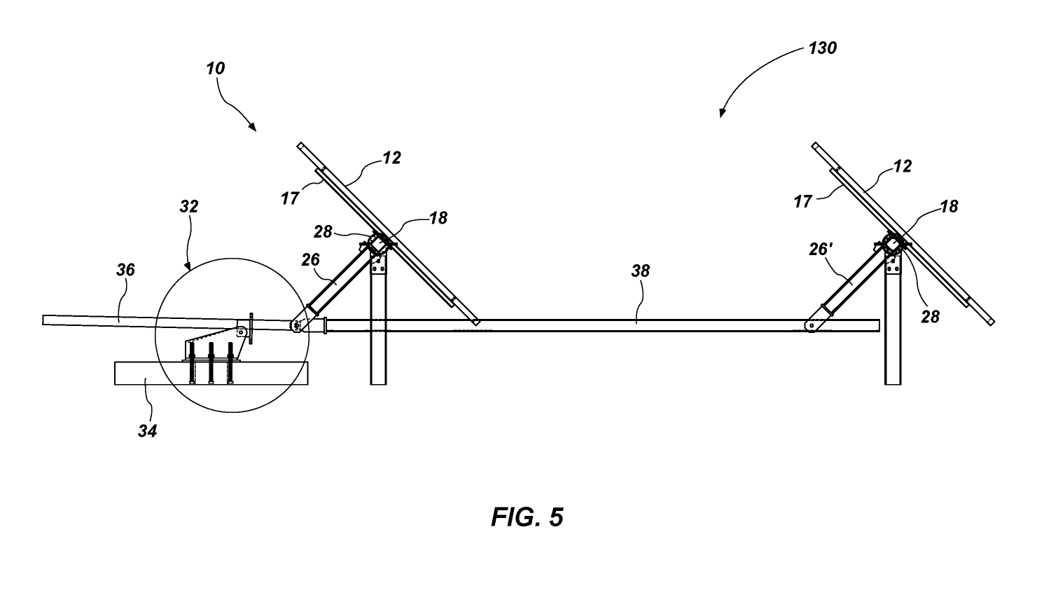

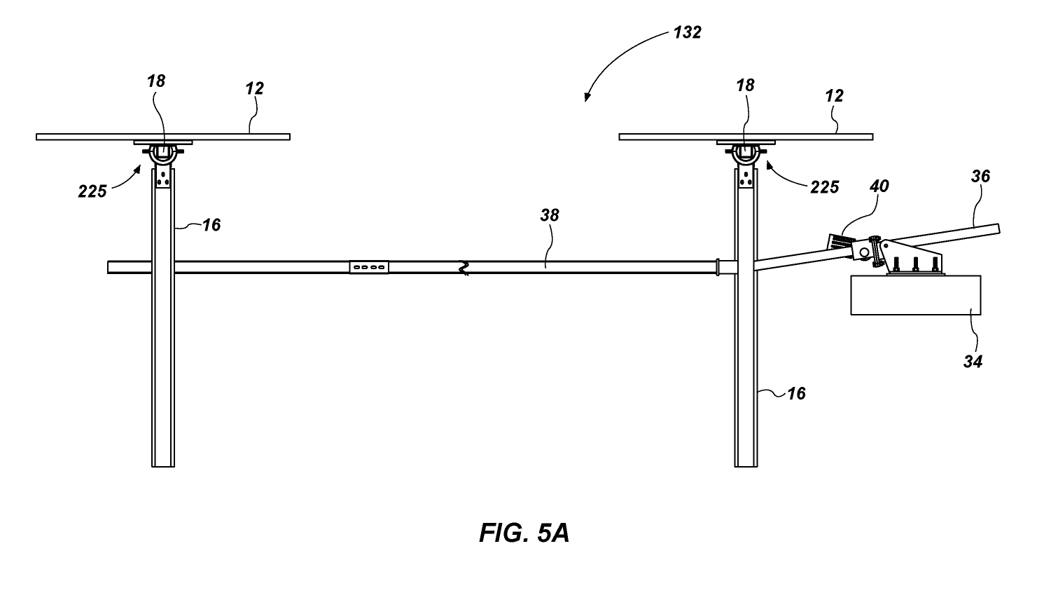

Referring to FIG. 5 a side view of the tracker system 10 (which may also be the tracker system 110 of the alternate embodiment) is depicted in a first configuration 130. An actuating mechanism 32 is secured to a base 34. The base 34 may be cement or other secure material that allows for sufficient securing of the mechanism to the ground. The actuating assembly 32 may comprise an actuator 36, or actuating screw, which engages at least one control bar 26 on at least one row 14 of PV modules 12. The actuator 36 may also engage a drive bar 38, or drive strut, that connects to at least one second row 14 of PV modules that may also include a control bar 26′ that engages a separate cross bar 18′.

The control bar 26 is pivotally connected to the actuator 36 and secured to at least one cross bar 18. The actuator 36 translates from a first position to a second position as the PV modules 12 track the sun the actuator moves in a linear fashion. The control bar 26 pivots with the movement of the actuator 36 thus rotating the cross bar 18 and the PV modules 12 they are attached to. The cross bar 18 is able to rotate freely about the axis because of the bearings 28 secured to the support members 16 via the brackets 30. The cross bar 18 and thus the PV modules 12 may move and stop at any number of positions because of the partially spherical, or circular in cross section, of the bearings 28 and associated brackets 30. While the PV modules 12 and the movement of the actuator and control bars may prevent a full 360° rotation the number of positions of which the cross bar 18 and thus the PV modules is infinite.

Referring to FIG. 5a, a second configuration 132 may be when the PV modules may be positioned parallel or substantially parallel to the ground. While it is appreciated that the tracker systems described herein can be positioned at an infinity number of positions, for illustrative purposes these configurations are depicted herein.

Referring to FIG. 6 an enhanced view of the actuating assembly 32 with the actuator 36 is shown engaged with the base 34 with numerous bolts, nuts or other securing features. A motor 40 may be connected to and biased to one side of the actuator 36 and may be capable of moving, pushing, pulling the actuator 36 such that it moves the control bars 26 allowing the PV modules 12 to rotate.

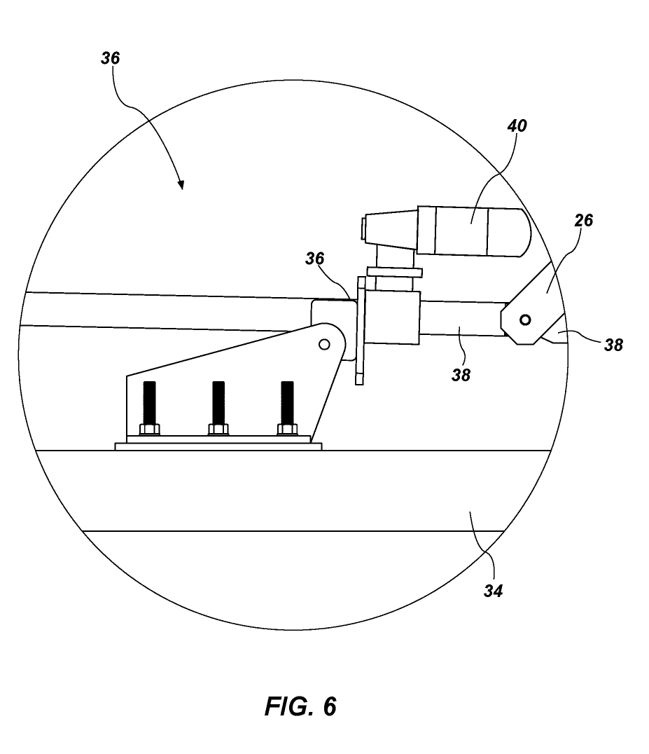

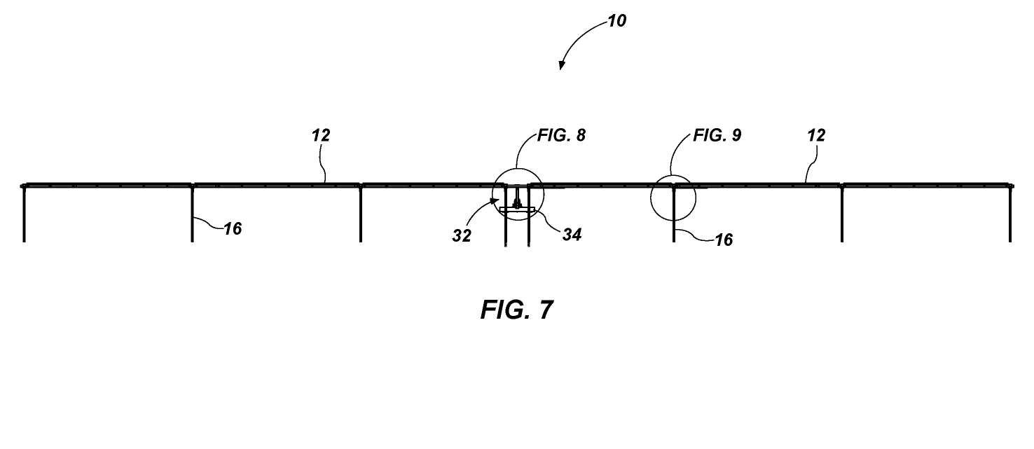

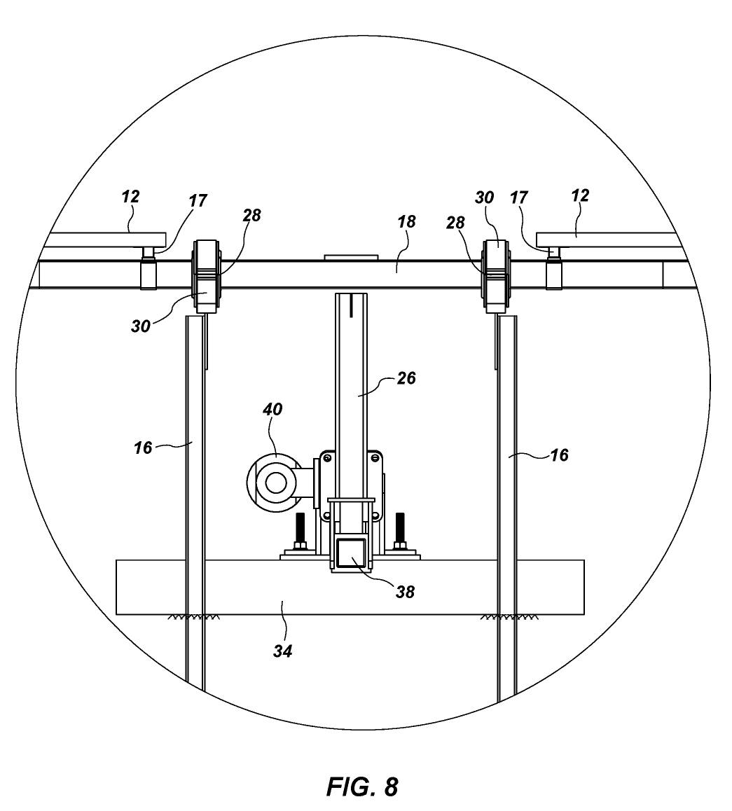

Referring to FIG. 7 and FIG. 8 a side view of the tracker system 10 is depicted which may depict how the support members 16 are positioned in the ground as shown by the base 34 being level with the ground. The support members 16 may all be the same or similar length and each are driven into the ground the same distance. Specifically with regard to FIG. 8 the actuator assembly 32 is enhanced and shows the base 34 with the motor 40 biased toward one side of the actuator 36. The actuator 36 may extend in a plane parallel to the ground and that may be perpendicular to the plane of the image on the page of FIG. 8.

The actuator 36 may be an actuator screw, or actuator rod, that rotates by the power of the motor to both extend and retract the actuator 36 in a single plane that allows the actuator to manipulate the control arms 26, 26′ either directly and thus rotating the control arms 26, 26′ about the cross bar 18 axis or through the drive bar 38 translationally and in the same plane as the actuator 36. The motor 40 may be capable, and of sufficient strength and capacity, of providing enough force to actuate and thus rotate more than ten rows 14 of PV modules 12 as set forth herein.

The first set of support members 16, may be positioned just lateral the actuator assembly 40, but within the width of the base 34 and may include the brackets 30 that maintain and secure the bushings 28, or bearings, to the support members and thus secure the cross bar 18 to the support members 16.

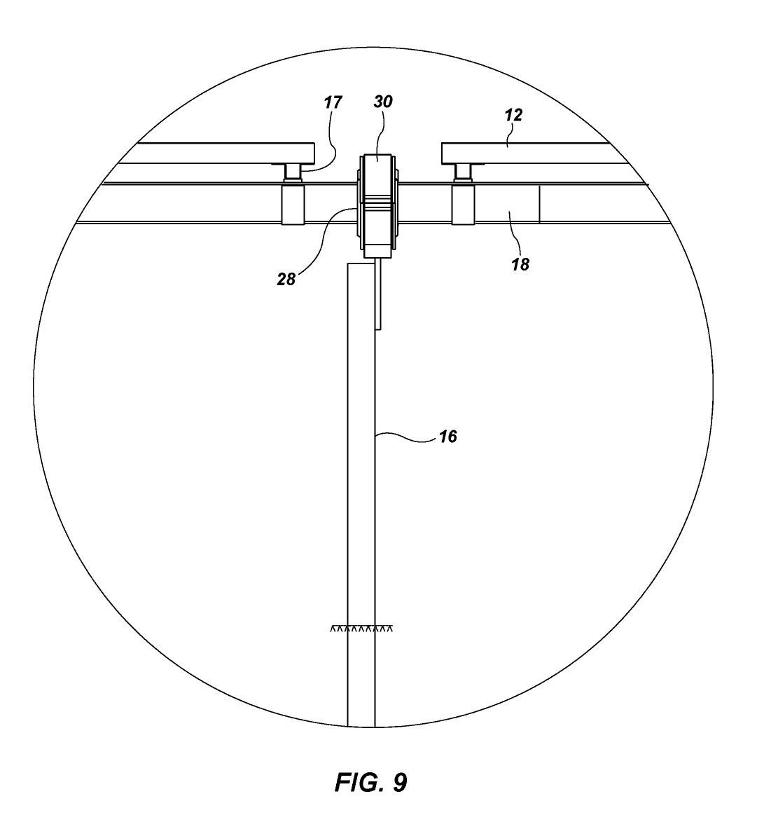

Referring to FIG. 9 a separate support member 16 which may be lateral the first set of support members may be substantially similar to the previous support members 16 as depicted in FIG. 8; however, the support member 16 in FIG. 9 may be of different dimensions that allow use of less material while providing the same stability as set forth previously herein. The same or similar brackets 30 that maintain the bushing 28 are utilized that secure the cross bar 18 to support member(s) 16.

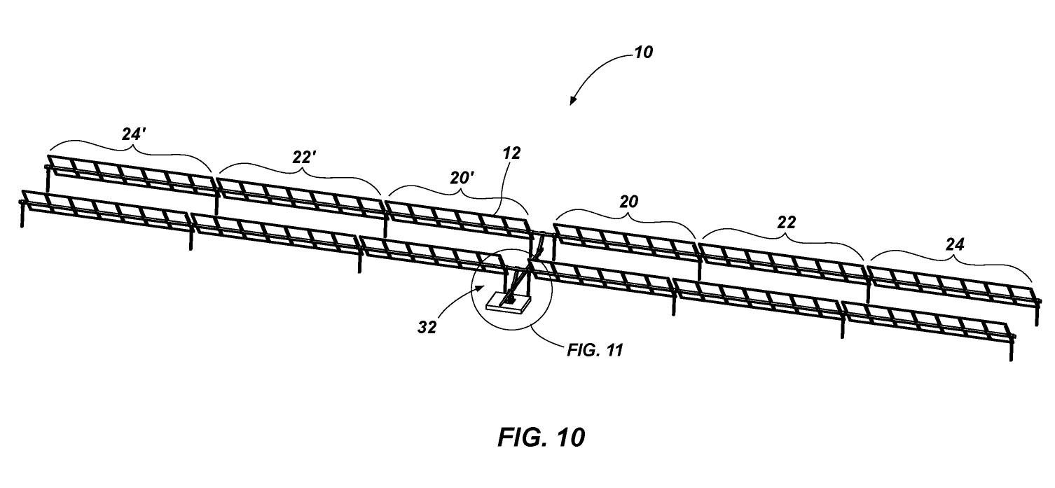

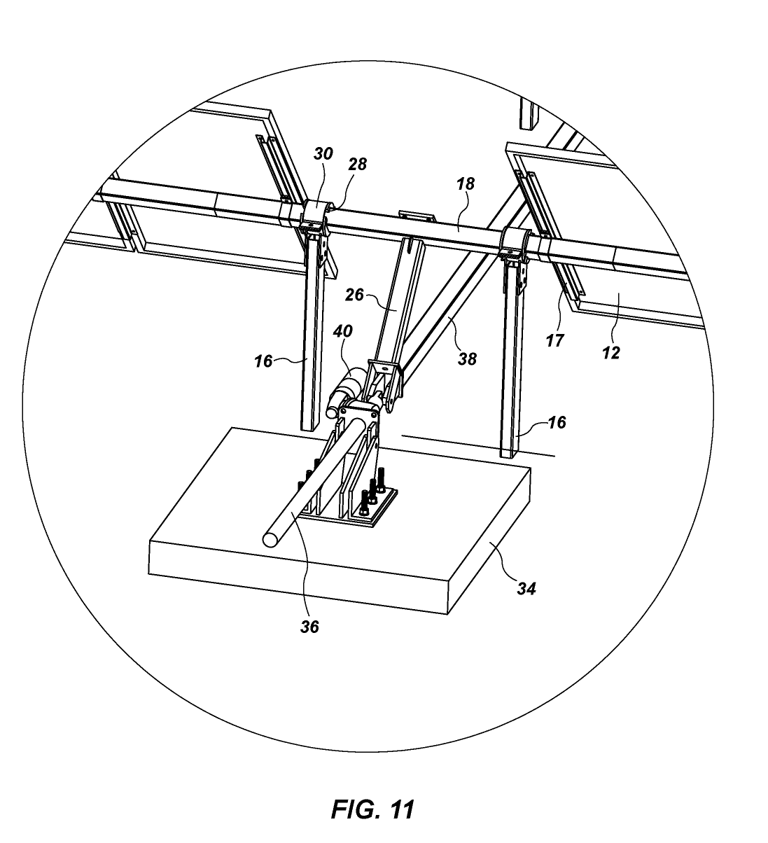

Referring to FIG. 10 and FIG. 11 a perspective, or isometric, view of the previous embodiment set forth herein is depicted with a plurality of rows 14 of PV modules 12 with the actuation assembly 32 in close up perspective view. While the base 34 may show at least six screws or bolts that secure the actuation assembly 32 to the base 34 it will be appreciated that any number of screws may be utilized that are of sufficient strength and size to provide adequate support and engagement of the assembly 32 to the base 34.

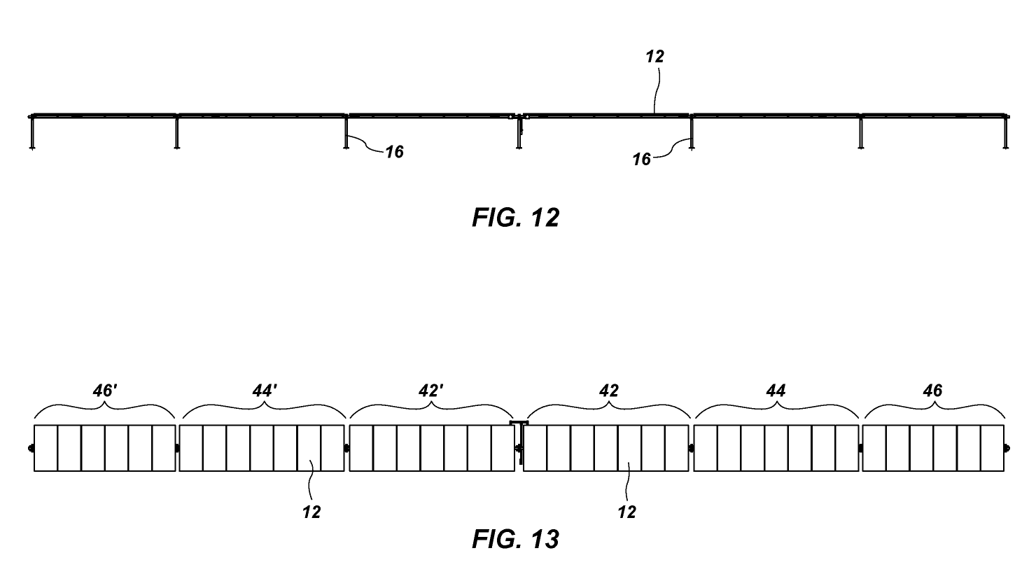

Referring to FIG. 12 and FIG. 13 an alternate arrangement of PV modules 12 is depicted then previously disclosed. While the total number of PV modules may be the same or similar to the previous embodiment as depicted and described in earlier figures, the “set” or “series” of modules may be different in that a first set of PV modules 42, 42′ includes seven (7) PV modules which may be positioned just lateral the actuation assembly 32 and just lateral a first pair of support members 16. A second set of PV modules 44, 44, which may comprise seven (7) PV modules, may extend laterally from the first set of PV modules 42, 42. A third set of PV modules 46, 46′, which may comprise six (6) PV modules, may extend laterally from the second set of PV modules 44, 44′.

Each of the PV modules 12, regardless of the number and of which embodiment, are secured to the cross bar 18. The PV modules 12 may be secured by a standard U-bolt or other similar bolt that substantially engages each side of the outside of the polygonal cross bar 18.

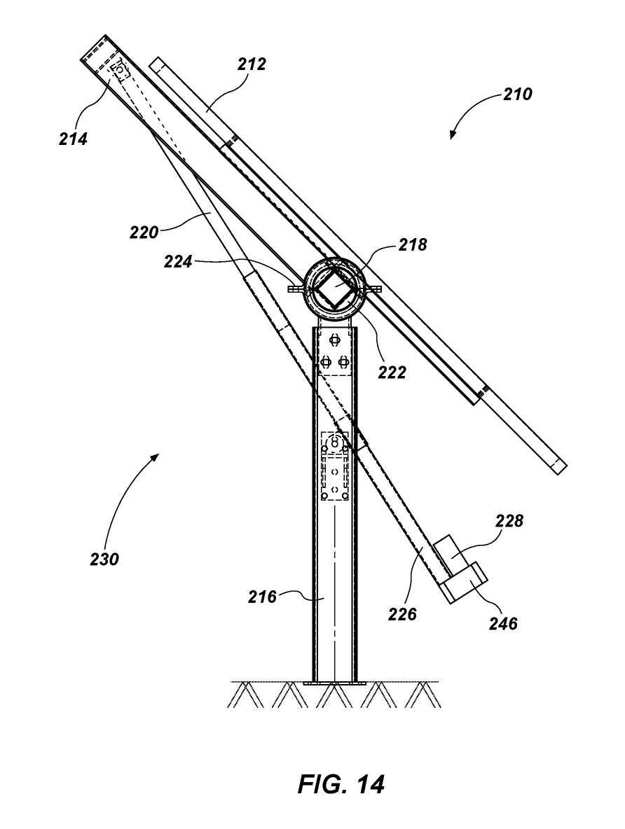

Referring to FIG. 14, an alternate embodiment of a single (or double) PV module tracker system 210 may include a single or double PV module 212 secured to a frame 214 with a support member 216, or pedestal pole, or pole, a cross bar 218, a control bar 220, or drive bar, a bushing 222 with a bracket 224, an actuator 226 and a motor 228. The PV module 212 may be secured to the frame 214 by screw, nuts, bolts, brackets or similar. The frame 214 may be secured to the cross bar 218 on one side of the frame 214. The control bar 220 may engage the frame 214 on the end opposite of the frame 214 from where the cross bar 218 and the frame 214 connect. The cross bar 218 may pass through the bushing 222, or bearing, similar to the previous embodiments. The bushing 222 may be secured to cross bar 218 by engaging the cross bar 218 on each of sides of the cross bar 218 which may be rectangular in cross section or any other polygonal shape with a complementary fit with the bushing 222.

The bushing 222 may be secured to the support member 216 via the bracket 224 that circumferentially engages the bushing 222. The bracket 224 may be two semi-circular pieces and the bracket is secured to itself by screws or bolts or snaps or other well-known means. The bracket 224 may be engage the support member 216 with a flange that extends from one end of one of the semi-circular pieces of the bracket 224 and may complementary engage the support member 216 in a groove of the support member 216 and then is secured with screws, nuts, bolts, brackets or other well-known means. The support member 216 may be secured to cement or placed in the ground at sufficient depth to provide stability.

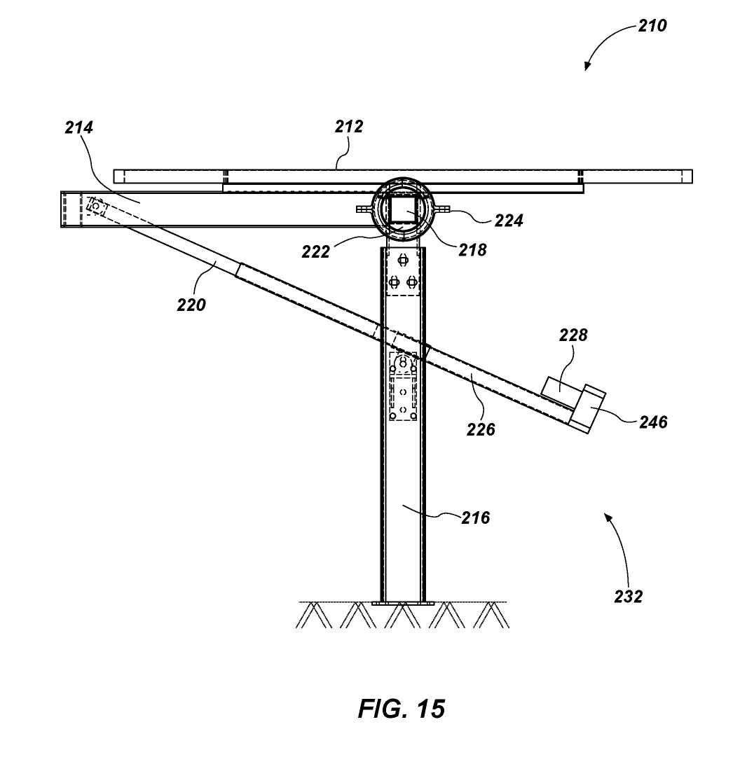

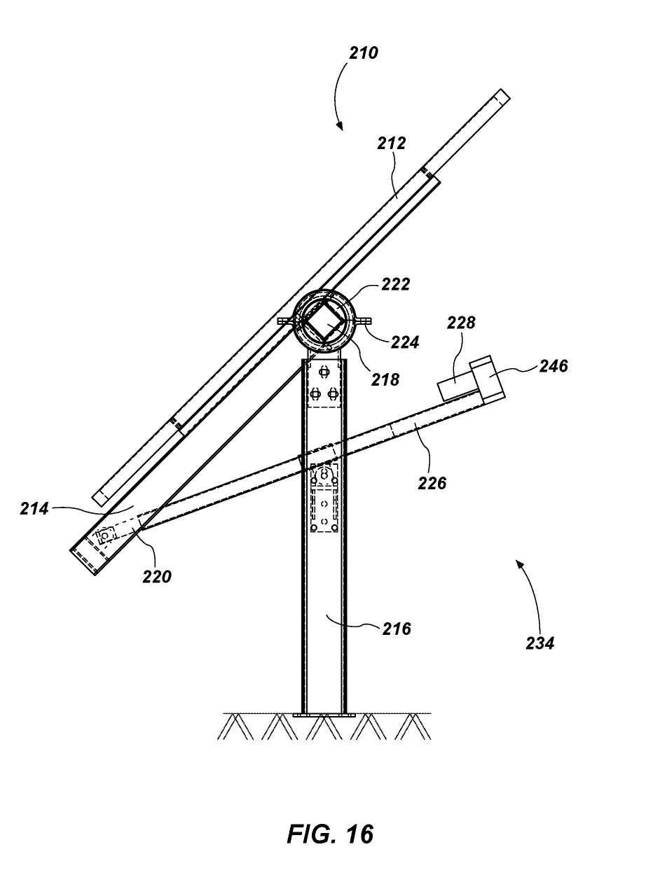

Similar to the previous embodiments the tracker system 210 may be able to adjust to an infinite number of locations because of the spherical or semi-spherical nature of the bushing 222 and the ability of the motor to manipulate the system 210 to track the sun. A first position 230, or first configuration, may be that depicted in FIG. 14 wherein the system 210 positions the PV module 212 to track the sun which may be in the morning. A second position 232, or second configuration, may be depicted in FIG. 15 wherein the system 210 positions the PV module 212 to track the sun which may be mid-day. A third position 234, or third configuration, may be depicted in FIG. 16 wherein the system 210 position the PV module 212 to track the sun which may be late afternoon or evening. While each of these positions is relative and not exact it provides an example of the movement of the system 210 to allow the PV module 212 to follow the pattern of the sun. The tracker system 210 depicted in these series of figures may also be construed for the previous embodiments with multiple PV modules 12 and multiple rows 14 of PV modules with the same concept.

The three configurations provided herein are for illustrative purpose only and are meant to be example and not limiting to the any number of infinite locations, positions and configurations that may be provided because of the nature of the cross bar 218 (or 18 in the previous embodiment(s)) interacting with the bushing 222 (28 of the previous embodiment(s)).

Referring to FIG. 17 the bracket 224 is shown with the flange engaging the support post 216 as well as “holding” the bushing 222. The cross bar 218 passes through the bushing 222 allowing the cross bar to be rotated within the bushing 222 to any of a plurality of positions.

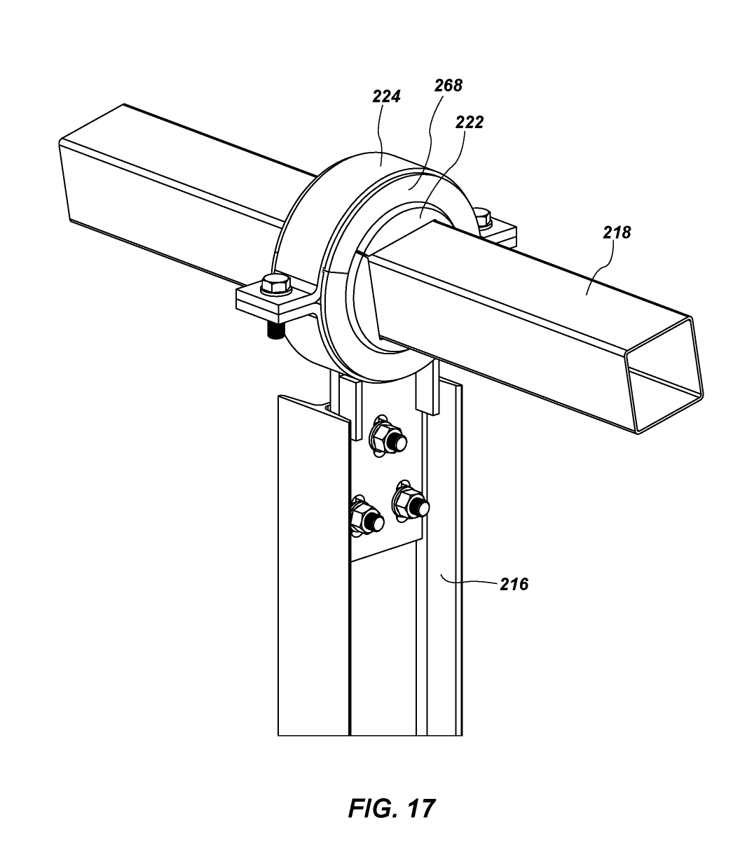

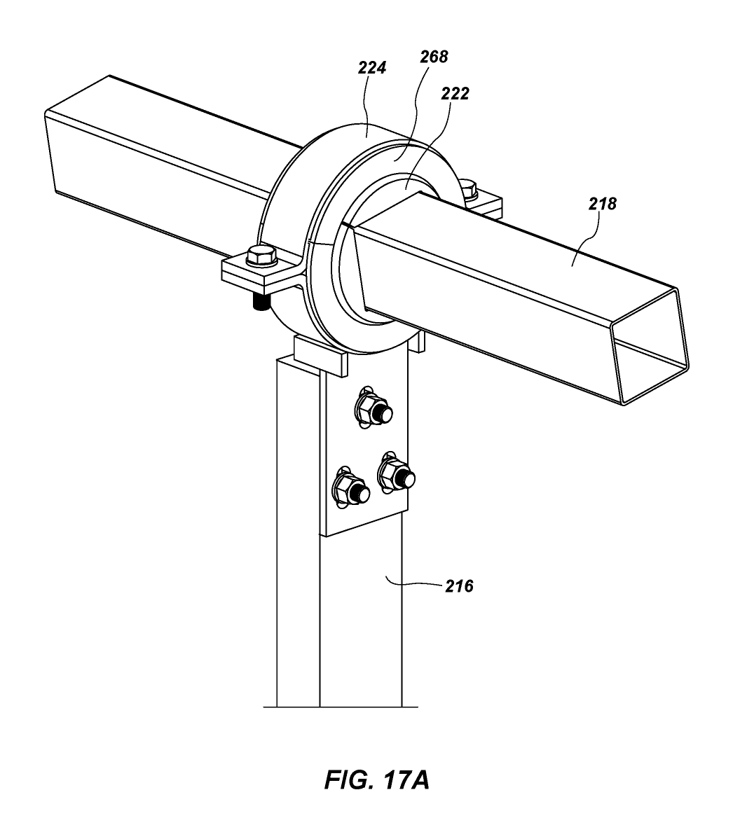

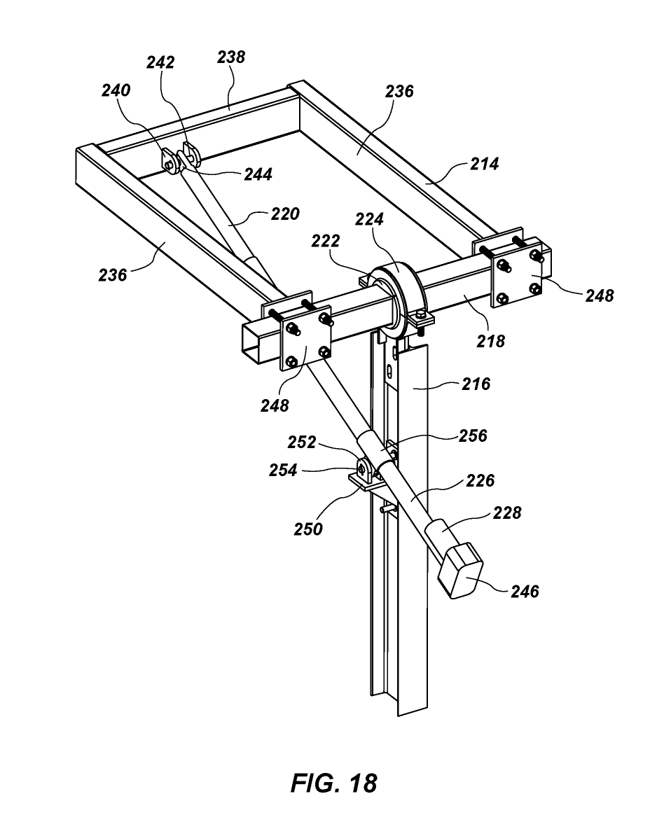

Referring to FIG. 18 the tracker system 210 is shown without the PV module 212 in place. The frame 214 may be substantially rectangular in shape to provide stability for the PV module 212 while also providing engagement for the control bar 220 to connect to the frame 214 and manipulate the frame 214 to rotate the PV module 212. The frame 214 may comprise two substantially parallel frame posts 236 and one frame cross post 238 joining the two parallel frame posts 236. A small bracket 240 with a bracket pin 242 on the frame cross post 238, opposite the cross bar 218, with the small bracket 240 projecting toward the opposite side of the frame 214 and may include a hole, or series of holes, to allow the bracket pin 242 to pass through. The bracket 240 may engage the control bar 220, at a distal end, by the bracket pin 242 passing through a hole 244, or series of holes, toward the distal end of the control bar 220. The control bar 220 may engage the actuator 226, or actuator rod, at the proximal end of the control bar 220 and the distal end of the actuator 226. A gear box 246 may engage the actuator 226 at the proximal end of the actuator 226. The gear box 246 may engage the motor 228 that manipulates the gear box 246 that manipulates the actuator 228 that forces the control arm 220 to manipulate the frame 214.

The frame 214 may include cross bar brackets 248, which may be U-bolts, or flat plates on each side of the cross bar 218 joined together by bolts and/or screws. The cross bar brackets 248 may secure the frame to the cross bar such that the frame may be connected in the same plane as at least one side of the cross bar 218 and in the case of a rectangular cross bar 218 the same plane as two sides, or the opposing sides, of the rectangular cross bar 218.

The support member 216 may include an arm 250 that may extend laterally from the body of the support member 216. The arm 250 may include an arm bracket 252 that includes a pin 254. The arm 250 with the pin 254 may engage a tubular bracket 256 that the actuator 228 passes through. The tubular bracket 256 includes a hole or series of holes that the pin 254 may pass through securing the actuator 228 to the support member 216. The arm 250 may be secured to the support member through any number of means including welding, screws, bolts etc.

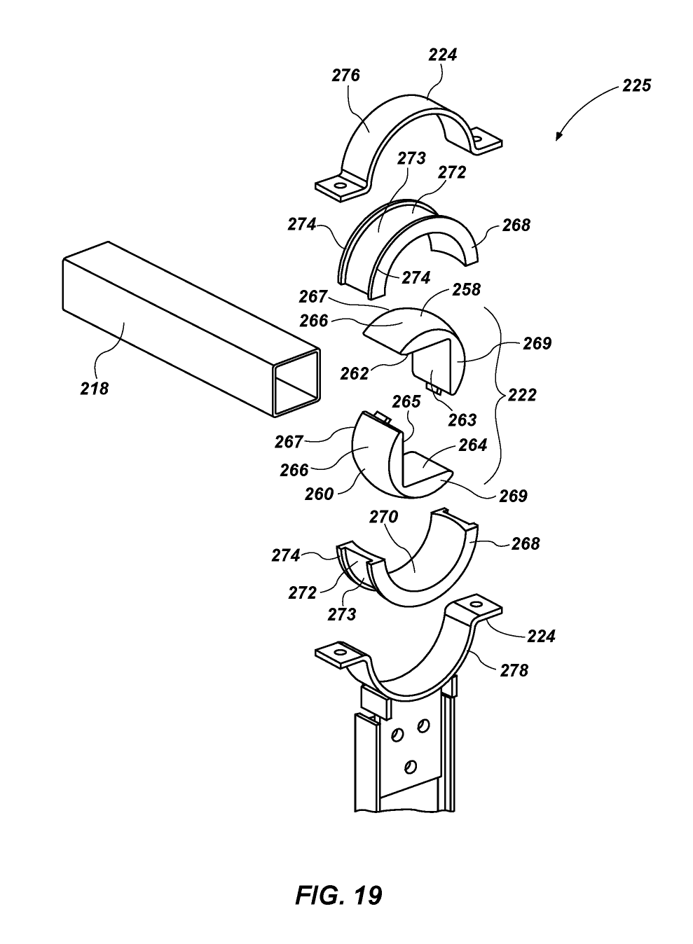

Referring to FIG. 19 and FIG. 21, an exploded view of the bracket 224 that may circumferentially surround the bushing 222 as well as a housing member 268 which all together comprise a bearing system 225. The bushing 222 may include a first L-shaped member 258 and a second L-shaped member 260 that may fit together through any number of means including snap fit, press fit, glue, welding, screws, etc. The two L-Shaped members 258, 260 may include tabs extending from one side of each L-shape and with corresponding engagement features that may compliment the tabs to secure the two L-shaped members 258, 260 together. The two L-shaped members 258, 260 may be reversibly secured together to allow easy replacement and/or removal if necessary. The first L-Shaped member 258 may include inner walls 262, 263 that may be substantially perpendicular to complement the rectangular cross bar 218. However, the inner walls may be more than two and may be any polygonal shape that complements the cross bar 218. The second L-Shaped member 260 may include substantially similar or the same inner walls 264, 265 on opposite sides of the inner walls 262, 263 of the first L-shaped member 258 respectively to engage the other side of the cross bar 218 that are not engaged by the first L-shaped member 258. The L-Shaped members 258, 260 may further include lateral walls 267, 269 that are on opposite sides of the inner walls 262, 263, respectively, and may be substantially planner and may be substantially parallel to one another and perpendicular to the inner walls, 262, 263, 264, 265. The L-shaped members 258, 260 may each include an exterior wall 266 which may be substantially, and at least partially, spherical and may circumferentially extend from one inner wall 262 to the other inner wall 263 on the first L-Shaped member 258 as well as from one inner wall 264 to the other inner wall 265 of the second L-shaped member 260 as well as extend from the lateral walls 267, 269.

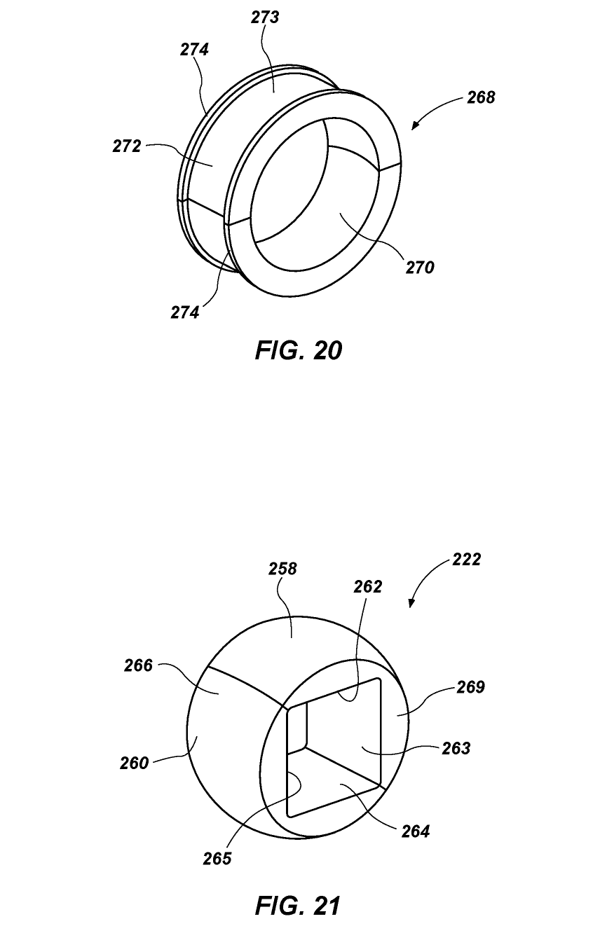

Referring to FIG. 19 and FIG. 20 the bushing 222 may be surrounded by the housing member 268 that may include a concave inner housing wall 270 to complement the spherical shape of the exterior wall 266 of the bushing 222. The housing member 268 may also include an outer wall 272 and two lateral lips 274 extending in a plane different from the outer wall 272 thus forming a channel 273. The housing member 268 may be comprised of multiple pieces that fit together to surround the bushing 222 or it may be a single piece that holds the bushing 222 inside. The bracket 224 may include a top member 276 and a bottom member 278 that circumferentially surround the housing member 268. The outer wall 272 may engage the top member 276 and the bottom member 278 between the lateral lips 274 within the channel 273. The lateral lips 274 may hold the bracket in place to prevent lateral movement of the bracket 224 on the housing member 268. The top member 276 and bottom member 278 may be secured together with screws, nuts, bolts, glue, welding, or other well-known means in the art. extend circumferentially

The housing member 268 and the bushing 222 may be comprised of the same or substantially the same material. The material may be nylon or other polymer. It will be appreciated though that metal may also be used for one or the other of both of the housing member and the bushing 222.

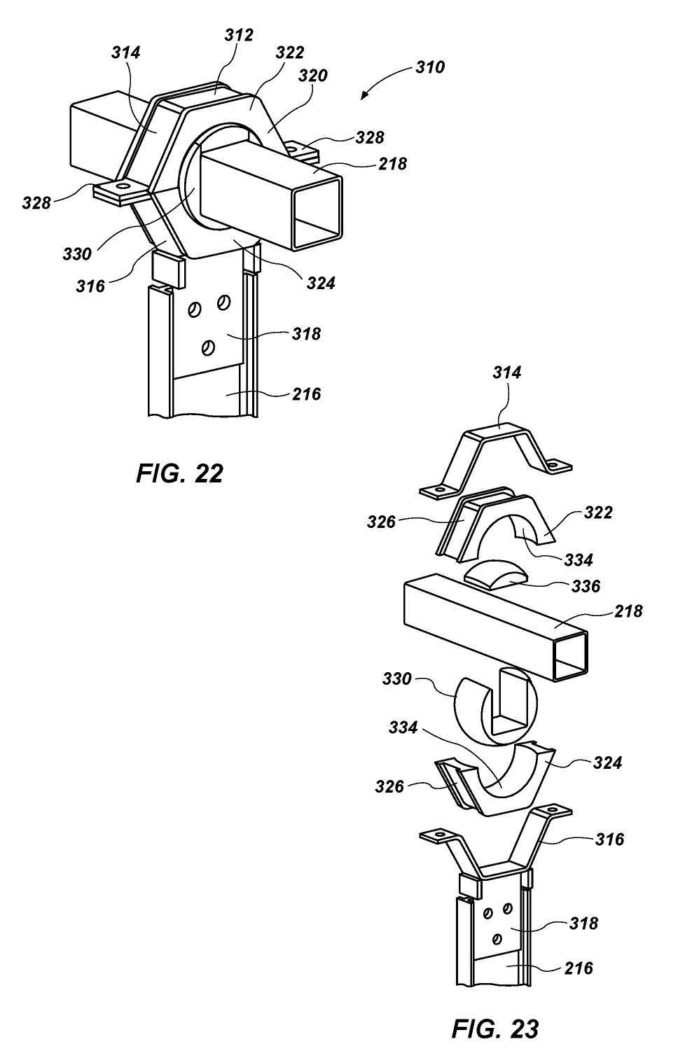

Referring to FIG. 22 and FIG. 23 an alternate embodiment, or alternate assembly, of a bearing system 310 is depicted with many of the same or similar components of the previous bearing system 225. In the current embodiment of the bearing system 310 a bracket 312 may resemble a hexagonal shape with a top member 314 being one-half of the hexagonal and capable of being secured to a bottom member 316 being one-half of the hexagonal. A flange 318 may extend from the bottom member 316 to be secured to the support member 216. A housing member 320 may resemble the shape of the bracket 312 with a top piece 322 and a bottom piece 324 that fit together to form the housing member 320. The housing member 320 may be hexagonal as well and include channel 326 in both the top piece 322 and bottom piece 324. The groove 326, or grooves, may run along the circumference of the housing member 320 and allow the bracket 312 to reside within the grooves 326. The bracket 312 may also include laterally extending wings 328 that may include holes that allow a bolt, screw or other feature for securing the top member 314 to the bottom member 316.

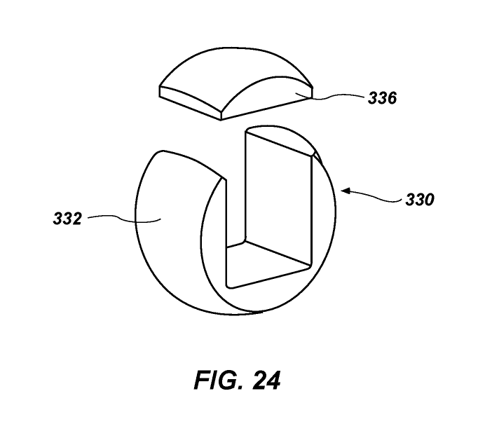

Referring to FIG. 22 thru FIG. 24, and similar to the previous embodiment, a bushing 330 may reside within the housing member 320 with a spherical exterior wall 332 that complements an inside wall 334 of the housing member 320, such inside wall 334 being concave. The bushing 330 may comprise a substantial U-shape with a cap 336 that completes the bushing 330 that is configured to receive the cross bar 218. However it will be appreciated that the previous embodiment bushing 222 may also be used in this configuration and vice versa.

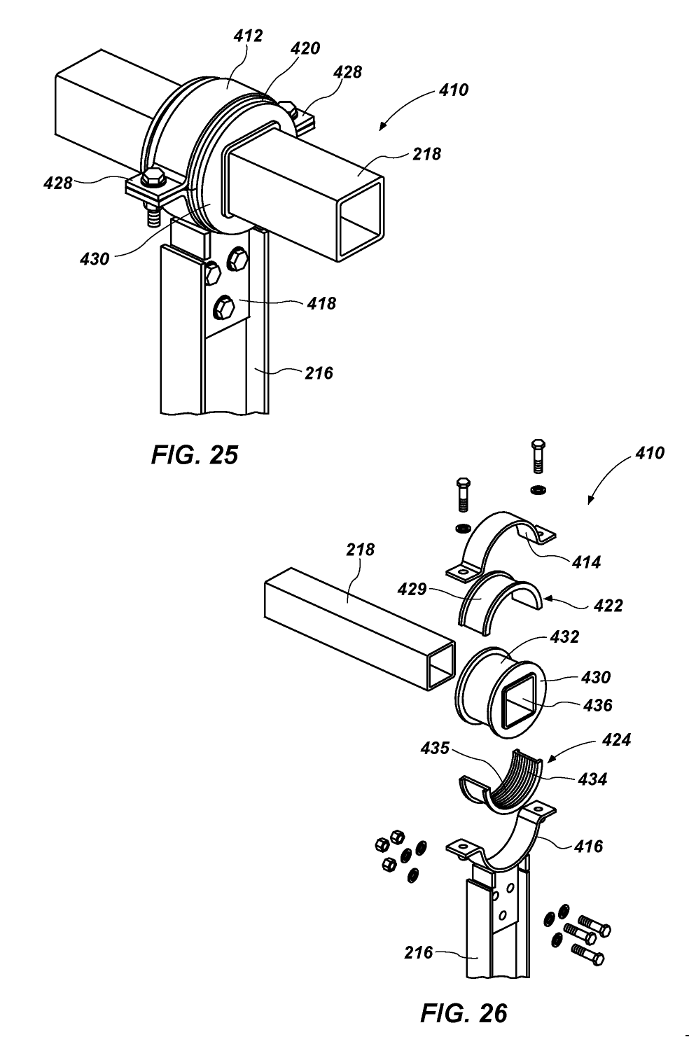

Referring to FIG. 25 and FIG. 26, an alternate embodiment, or alternate assembly of a bearing system 410 is depicted. A bracket 412 may be similar or substantially similar to the previous embodiment with the spherical bushing 222 with a top member 414, bottom member 416 and a flange 418 extending from bottom member 416 and configured to be secured to the support member 216. The bracket may include the same or similar laterally extending wings 428.

Alternatively, a housing member 420 may comprise a top piece 422 and a bottom piece 424 that when joined together form a cylinder configured to maintain and engage, circumferentially, a bushing 430. The housing member 420 may include a channel 429 that runs along the circumference of the housing member 420 and maintains the bracket 412 within the channel 429. The bushing 430 may include a bushing groove 432 that extends circumferentially around the outside of the bushing 430 and is configured to maintain and engage the housing member 420.

An inner wall 434 of the housing 420 may comprise multiple grooves 435, or ridges, that may engage the bushing 430. The bushing 430 may be substantially cylindrical in shape and may include an aperture 436 passing longitudinally through the cylinder. The aperture 436 may be any polygonal shape that may complementary engage the cross bar 218 to allow rotation of the cross bar 218 within the bearing assembly 410. The bearing assembly 410 may be comprised almost entirely of a metal; however, it may also be comprised of other materials including plastics, polymers, carbon-fiber or nylon.

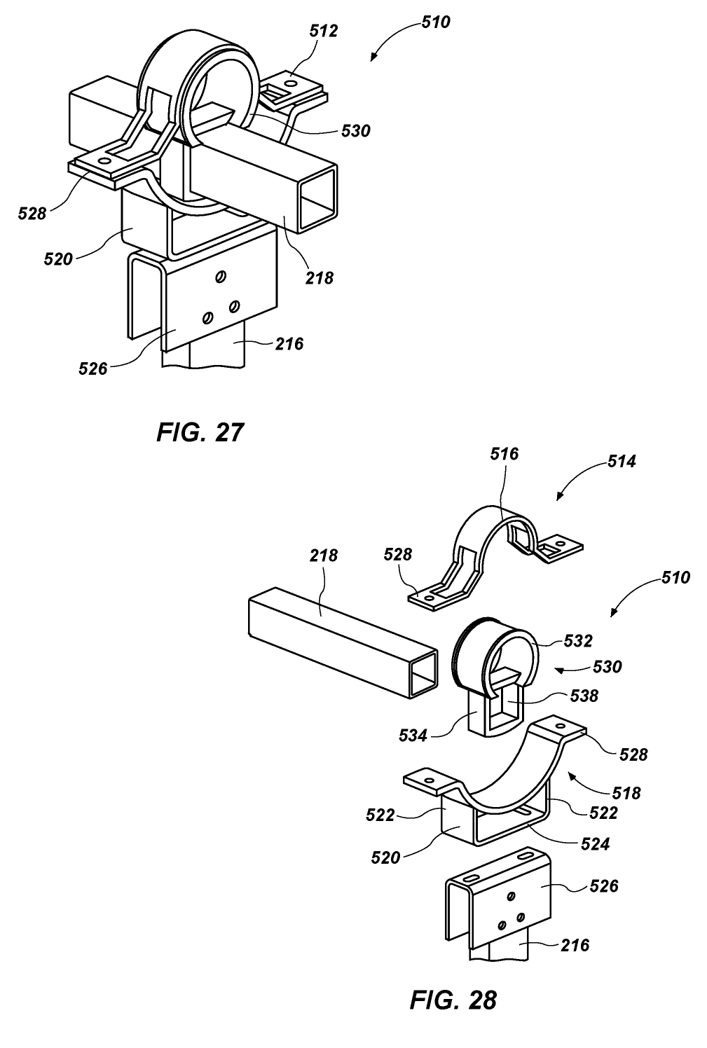

Referring to FIGS. 27 and 28, an alternate embodiment, or alternate assembly, of a bearing system 510 is depicted. The bearing system 510 may include a bracket 512 that includes a top member 514 with a bulbous head 516 configured to engage a head 532 of a bearing 530. The bracket 512 may also include a bottom member 518 that is more rounded than the bulbous head 516 of the top member 514. The bottom member 518 may engage a bearing protrusion 534 that extends from the head 532 of the bearing 530. The bottom side of the protrusion 534 may be rounded so as to slide or glide along the bottom member of the bracket while the head 532 resides within the bulbous head 516 of the top member 514 the head 532 rotating within the bulbous head 516. The bracket's 512 top member 514 and bottom member 518 may each comprise wings 528 that extend and engage one another and may be secured to one another to hold, and maintain, the top member 514 to the bottom member 518 and hold the bearing 530 tightly.

The protrusion 534 may include an opening 538 that may be substantially rectangular in cross-sectional shape. The opening 538 may allow the cross bar 218 to pass there through. However, any shape opening 538 may be utilized that may complement the shape of the cross bar 218.

The bottom member 518 of the bracket may also include an extension 520 that extends from the bottom of the bottom member 518. The extension 520 may be substantially rectangular in shape and may include two planar walls 522 extending from the bottom member 518 and a third planar wall 524 extending perpendicular to the two planar walls 522 and connecting the two planar walls 522. The extension 520 may provide stability to the bearing system 510 and may provide engagement of the bearing system 510 to the support member 216. The third planar wall 524 may lay flush against a support member bracket 526 that may reside on one end of the support member 216. The support member bracket 526 may be secured to the support member 216 and may include a top planar surface that may engage the third planar wall 524. The support member bracket 526 may be secured to the extension member 520 through, nuts, bolts, welding or other means in the art.

The bearing system 510 may rotate the cross bar 218 through means previously disclosed herein; however, the bearing 530 may function with the protrusion 534, with the cross bar 218 passing there through, being manipulated to cause the protrusion 534 to glide along the inside of the bottom member 518 of the bracket 512 and thus causing the head 532 to rotate within the bulbous head 516 of the top member 514 of the bracket 512.

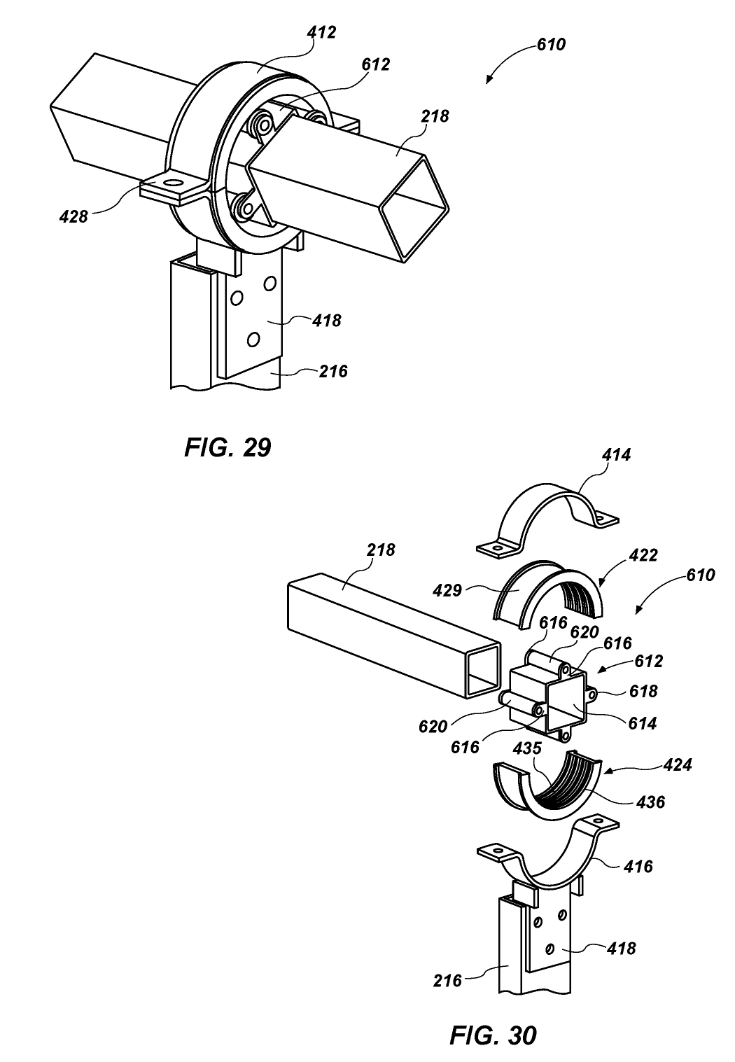

Referring to FIG. 29 and FIG. 30, an alternate embodiment of a bearing system 610 is depicted that is substantially similar to the previous embodiment bearing system 410. Each of the elements of the bearing system 610 may be the same or similar to the previous embodiment bearing system 410 (refer to FIGS. 25 and 26) with the exception of a bearing 612. The bearing 612 may be substantially rectangular in cross sectional shape (or any other polygonal shape that will match the cross bar 218) with a hole 614 passing there through to receive the cross bar 218. The bearing 612 may resemble a box with two open sides opposite each other that allows the cross bar 218 to pass straight there through. At each opening of the hole 614 a plurality of tabs 616 may extend laterally away from the opening of the hole 614. The tabs 616 may extend parallel to one another from the opposite sides of each opening of the hole 614. The tabs may include holes 618 that extend through the tabs 616. Cylinders 620 or pins may be positioned between two of the parallel tabs 616 and may be secured to the tabs through a pin, nut, bolt, screw or similar mechanism, such as press fit in between the two tabs 616. The pins 620 may freely rotate when engaging the housing member 420 thus allowing the bearing 612 to freely rotate within the housing member 420. Each side of the bearing 612 may include these tabs 616 and pins 618 and thus allow the bearing to freely rotate within the housing member 420.

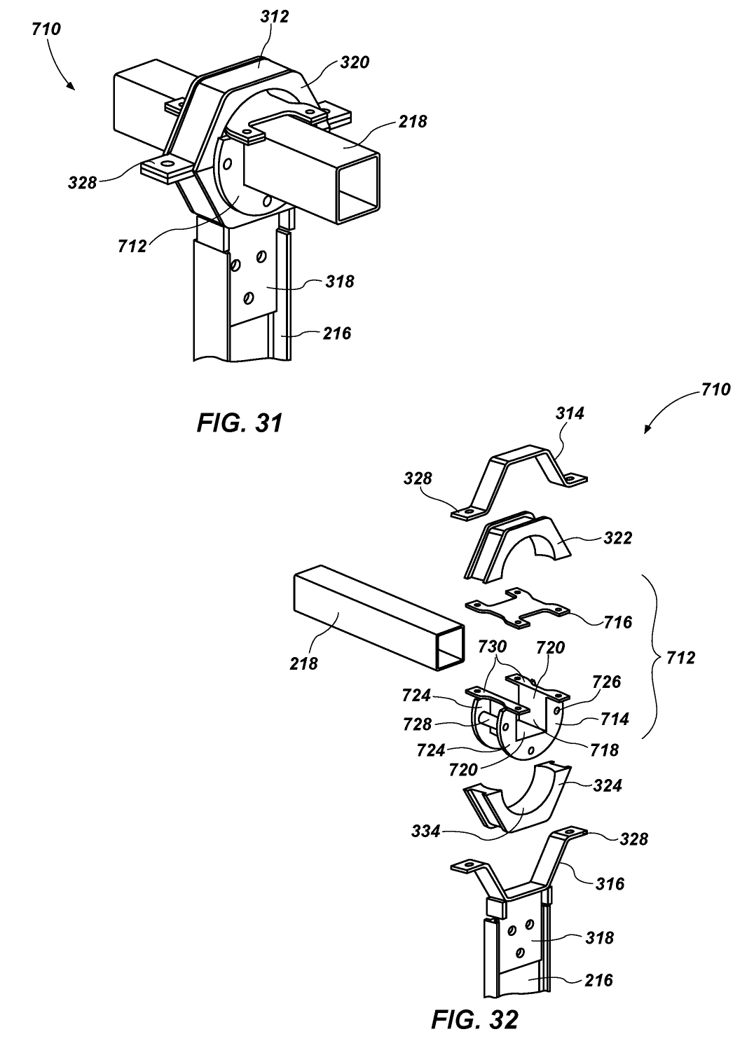

Referring to FIG. 31 and FIG. 32, an alternate embodiment of a bearing system 710 is depicted that is substantially similar to the previous embodiment bearing system 310. Each of the elements of the bearing system 710 may be the same or similar to the previous embodiment bearing system 310 (refer to FIGS. 22 and 23) with the exception of a bearing 712. The bearing 712 may include a first portion 714 and a second portion 716 with an aperture 718 passing there through. The first portion 714 may be a base portion and may be substantially U-shaped wherein the interior walls 720, or walls within the aperture 718, may be planar and configured to engage the cross bar 218. The exterior walls 722 may be substantially planar as well. A substantially circular flange 724 may project from each opening on each side of the aperture 718. The substantially circular flange 724 may provide walls as an engagement feature to engage the bearing 712 with the housing member 320. Holes 726 may be positioned on each of the three sides of the planar walls 722. Pins 728 or cylinders, similar to the previous embodiment (610), may engage the circular flanges 724 at the position of the holes 726 and may be secured to the flanges 724 and ultimately the bearing 712 through, screws, nuts, bolts, screw or similar mechanism, such as press fit in between the two circular flanges 724.

The second portion 716 may be a planar bracket that may engage the first portion 714 at a U-shape opening 728 that is perpendicular to the aperture 718. The second portion 716 may be secured to the first portion 714 by the first portion including two planar faces 730 that may extend from laterally from the U-shape opening 728. The planar faces 730 may allow the second portion 716 to sit flush on the first portion 714 and be secured to each other through known means such as screws, nuts, bolts or similar mechanism.

Similar to the previous embodiment (610), the pins 728 may freely rotate when engaging the housing member 320 thus allowing the bearing 712 to freely rotate within the housing member 320. At least three sides of the bearing 712 may include these pins 728 thus allow the bearing to freely rotate within the housing member 320.

Alternatively the pins 620, 728 of the previous embodiment may include pins that may engage the respective holes 618, 728 without requiring additional elements. The pins 620, 728 may have a larger circumference than the proximal and distal ends of the pins thus allowing the proximal and distal ends of the pins to pass through the respective holes 618, 728 without the body of the pins 620, 728 passing through. The 620, 728 pins may be spring loaded thus allowing the proximal and distal ends to easily be added or removed from the bearings 612, 712.

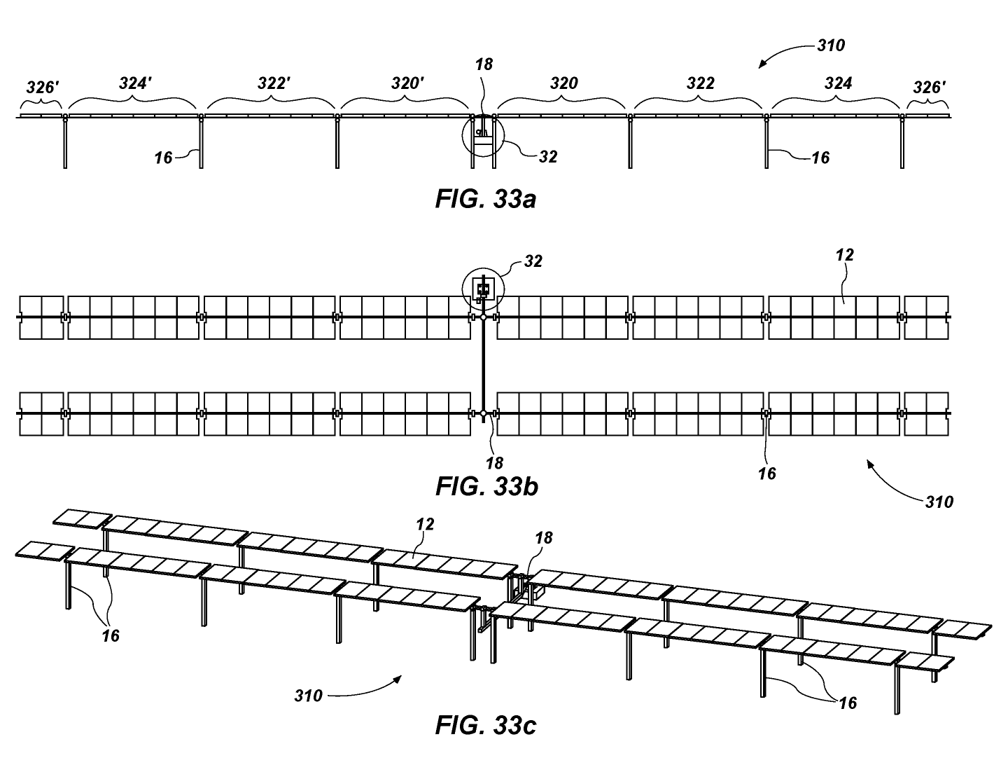

Referring to FIG. 33a-c, an alternate embodiment of a tracker system 310 is depicted. In this embodiment the PV modules 12 of the tracker system 310 may be positioned in a different series as other embodiments. A first set, or series, of PV modules 12 that extend from a central position of the system 10 may include a first set of PV modules 320, 320′, which may comprise six (6) PV modules that extend laterally from the center position. A second set of PV modules 322, 322′, which may comprise six (6) PV modules, may extend laterally from the first set of PV modules 320, 320′. A third set of PV modules 324, 324′, which may comprise six (6) PV modules, may extend laterally from the second set of PV modules 322, 322′. A fourth set of PV modules 326, 326′, which may comprise two (2) PV modules, may extend laterally from the third set of PV modules 324, 324′. Support members 16 may be positioned just lateral the center position or toward the center position and then another support member after the first set of PV modules 320, 320′ and then another support member 16 after the second set of PV modules 322, 322′ and then a last support member 16 after the third set of PV module 324, 324′ which may be at the end of the row 14 toward the end of the cross bar 18, or torque tube.

Although the foregoing disclosure provides many specifics, these should not be construed as limiting the scope of any of the ensuing claims. Other embodiments may be devised which do not depart from the scopes of the claims. Features from different embodiments may be employed in combination. The scope of each claim is, therefore, indicated and limited only by its plain language and the full scope of available legal equivalents to its elements.

What is claimed:

1. A system for tracking solar light, comprising:
at least one photovoltaic module (PV module) secured to a frame;
a torque tube secured to the frame;
a bearing system comprising:
a bracket with a first portion and a second portion, the second portion comprising a flange;
a housing member comprising a top portion and a bottom portion; and
a bearing comprising:
two L-shaped members configured to complementary engage one another to form a closed structure;
at least three planar interior walls; and
a spherical exterior wall.

2. The system of claim 1, wherein the bearing further comprises an aperture passing entirely through the bearing configured to receive the torque tube.

3. The system of claim 1, wherein the at least three planar interior walls comprise four planar walls; and
wherein the torque tube is polygonal in cross-sectional shape.

4. The system of claim 3, wherein the four planar walls comprise a rectangular aperture passing at least partially through the bearing; and
the torque tube is rectangular in cross-sectional shape and complementary engages the rectangular aperture.

5. The system of claim 1, wherein the housing member comprises an internal groove configured to engage the spherical exterior wall of the bearing.

6. The system of claim 1, wherein the housing member comprises a circumferential channel on the exterior of the housing member configured to engage the bracket.

7. The system of claim 1 comprising a motor.

8. The system of claim 7 comprising an actuator engaged with the motor, the actuator secured to the torque tube and configured to rotate the torque tube.

9. The system of claim 8 wherein the at least one PV cell comprises a plurality of PV cells in a single row engaging the torque tube.

10. The system of claim 8 wherein the at least one PV cell comprises a plurality of PV cells in multiple rows, each row engaging a separate torque tube.

11. A system for tracking light, comprising:
a single photovoltaic module (PV module) secured to a single frame;
a cross bar secured to the frame;
a bearing system comprising:
a bracket with a first portion and a second portion, the second portion comprising a flange;
a housing member comprising a top portion and a bottom portion;
a spherically shaped bearing comprising a polygonal aperture passing there through, wherein the cross bar engages the spherically shaped bearing through the polygonal aperture;
wherein the spherically shaped bearing comprises two identical L-shaped members configured to engage one another to form the polygonal aperture.

12. The system of claim 1, wherein the polygonal aperture comprises a plurality of planar walls the compliment the cross bar, wherein the cross bar has a polygonal cross sectional shape that complements the polygonal aperture.

13. The system of claim 1, wherein each L-shaped member comprises a tab that engages to the other L-shaped member to secure the two L-shaped members together.

14. The system of claim 11, wherein the housing member comprises an internal groove configured to engage the spherical shaped bearing.

15. The system of claim 11, wherein the housing member comprises a circumferential channel on the exterior of the housing member configured to engage the bracket.

16. The system of claim 11 comprising a motor.

17. The system of claim 16 comprising an actuator engaged with the motor, the actuator secured to the cross bar and configured to rotate the cross bar.

18. A method of rotating a photovoltaic module (PV module) comprising:
securing at least one PV module to at least one frame;
securing at least one torque tube to the at least one frame;
securing at least one bearing system to the torque tube, the at least one bearing system comprising:
a bracket with a first portion and a second portion, the second portion comprising a flange;
a housing member comprising a top portion and a bottom portion; and
a bearing comprising:
two L-shaped members configured to complementary engage one another to form a closed structure;
at least three planar interior walls; and
a spherical exterior wall.

19. The method of claim 18 further comprising:
actuating an actuator rod with a motor and a gear box;
rotating at least one torque tube about a single axis with the actuator rode;
rotating the at least one torque tube within the at least one bearing system about the single axis, wherein the torque tube is polygonal in cross-sectional shape complementary fitting with the at least three planar interior walls of the bearing; and
rotating the at least one frame and at least one PV module that are secured to the at least one torque tube.

20. The method of claim 19 wherein the at least one frame comprises a plurality of frames and the at least one PV module comprises a plurality of PV modules and the at least one torque tube comprises a plurality of torque tubes and the at least one bearing system comprises a plurality of bearing systems; wherein the method further comprises:
actuating an actuator rod with a motor;
rotating the plurality of torque tubes about a plurality of torque tube axes with the actuator rod, wherein each torque tube comprises its own axis;
rotating the plurality of torque tubes within the plurality of bearing systems, wherein the torque tubes are polygonal in cross-sectional shape complementary fitting with the at least three planar interior walls of the bearing;
rotating the plurality of frames that are secured to the plurality of torque tubes; and
rotating the plurality of PV modules that are secured to the plurality of frames.
